(19) United States
(12) Patent Application Publication
(10) Pub. No.: US 2014/0147102 A1
(43) Pub. Date: May 29, 2014

(54) VARIABLE REAL TIME BUFFER AND APPARATUS

(71) Applicant: THOMSON LICENSING, lssy de Moulineaux (FR)

(72) Inventors: Lee Douglas Shartzer, Valencia, CA (US); Kenneth Alan Rudman, South Pasadena, CA (US); Barry Jay Weber, Carmel, IN (US)

(21) Appl. No.: 14/131,997

(22) PCT Filed: Jul. 27, 2012
(86) PCT No.: PCT/US2012/048521

§ 371 Date: Feb. 4, 2014

Related U.S. Application Data
(60) Provisional application No. 61/574,061, filed on Jul. 27, 2011.

(51) Int. Cl. H04N 5/775; H04N 5/781

(52) U.S. Cl. CPC H04N 5/775; H04N 5/781
USPC 386/341

(57) ABSTRACT

The present disclosure is directed to a time shifting approach for utilizing multiple tuners. The present disclosure makes use of a temporary buffer to record programs that a user may be interested in by having a variable buffer which stores programming which can be received from multiple tuners. The buffer space allocation per channel is variable so that the time duration recorded for the buffer changes.

### CROSS REFERENCE TO RELATED APPLICATIONS

This application claims the benefit of U.S. Provisional Application Ser. No. 61/574,061 filed Jul. 27, 2011, which is incorporated by reference herein in their entirety.

### BACKGROUND

1. Technical Field

This disclosure relates to the Digital Video Recorders (DVR's). More particularly, this disclosure is directed to managing a real time buffer in a DVR.

2. Description of Related Art

Previous buffer approaches keep fixed the amount of time allotted for recording. Although there may be approaches for recording programming as a DVR recording, and for is making tuners available for real time viewing, the concept of buffering real time programming which is not saved to a hard drive (like a DVR recording) has not been fully realized.

Hence, the present disclosure will allocate resources of the real time buffer to various tuners where the variables that are changed are the channels being tuned to, how long such channels are being tuned to, and how the space of the buffer is variably changed across the real time buffer depending on the characteristics of the programming and also the preferences of the user consuming content.

### SUMMARY OF THE INVENTION

The present disclosure is directed to a time shifting approach for utilizing multiple tuners. The present disclosure makes use of a temporary buffer to record programs that a user may be interested in by having an intelligent real time buffer which stores programming which can be tuned in from multiple tuners. The buffer space allocation per channel is variable so the time duration recorded for the buffer changes.

In accordance with one embodiment, a method for a DVR having a multiple tuners is provided. The method involves providing a real time buffer for storing content from the multiple tuners, determining which of the multiple tuners is available to make use of the real time buffer, and allocating space in the real time buffer to the available tuners.

In accordance with another embodiment, a DVR system is provided for allocating space in a real time buffer. The system includes multiple tuners, storage, a processor, and an output interface. The multiple tuners are configured to receive content. The storage is configured to provide a real time buffer. The processor is configured to determine which of the multiple tuners is available to make use of the real time buffer and allocate space in the real time buffer to the available tuners. The output interface is configured to output the content of the real time buffer.

### BRIEF DESCRIPTION OF THE DRAWINGS

FIG. 1 is a diagram depicting an environment in which a device using a real time buffer can be used.

FIG. 2 is a block diagram useful depicting the elements of a system in accordance with one embodiment of the present disclosure.

FIG. 3 is a flow diagram illustrating a methodology in accordance with one embodiment of the present disclosure.

FIG. 4 is a program guide in accordance with an embodiment of the present disclosure.

### DETAILED DESCRIPTION

The methodologies, systems and teachings disclosed herein can be embodied in or as a Digital Video Recorder (DVR) that can be implemented in a consumer electronic device, such as set top box that is capable of receiving a broadcast stream containing content.

A video/audio system exists for a person's home where there exists a number of tuners that can be used for selecting programming at the same time. The present disclosure makes use of tuners and then allocates a particular prioritization to the use of the tuners in view of specific functions being required of such tuners. These functions primarily being the viewing of television programming, buffering of current television programming which are being shown on other channels, and the recording of programming to a buffer such as a hard drive.

The prioritization of the tuners to support these functions is based on the type of functions that are required, the number of available tuners, and the personal preferences of the user.

In the examples described herein, the term “digital video recorder” or “DVR” is used for a device that provides the functionality of the disclosure. The term DVR is meant to include all such devices or software that are capable of recording, storing, and displaying or otherwise outputting content or programs. This includes Personal Video Recorders (PVRs), media servers, personal computers (PCs), or the like.

The term “broadcast streams” is used herein to refer to channels, IP streams, or the like on which content is provided to the DVR for which the tuners “tune to” to receive the content.

The term “content” is used herein to refer to television shows, movies, music, sports or music events, podcasts, or any other content provided by content providers that can be recorded, stored, streamed, and displayed or otherwise outputted by a DVR.

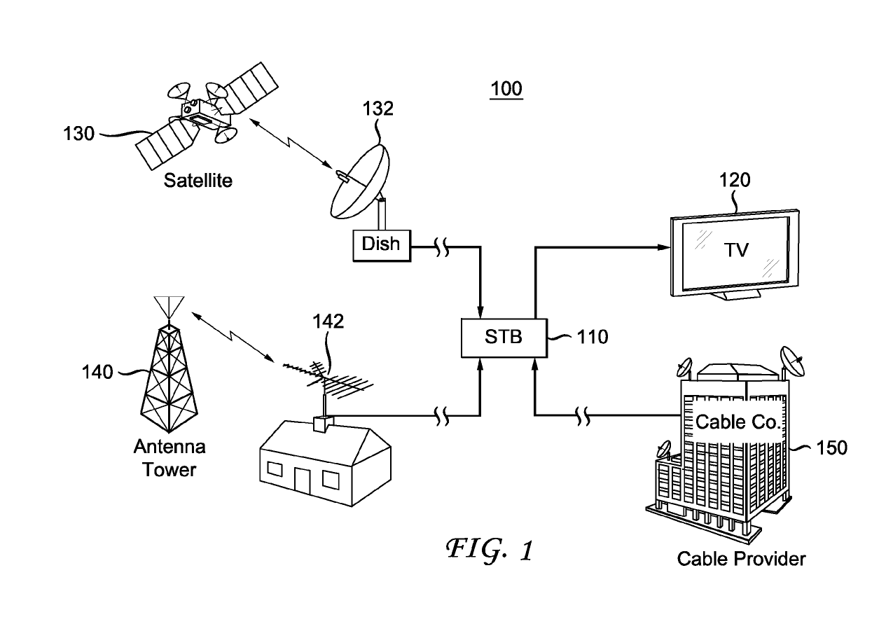

FIG. 1 depicts an environment 100 in which the variable real time buffer described herein can he employed. The environment includes a digital video recorder (DVR) 110. In this embodiment, the DVR is set top box (STB) that is connected to a user's display device and/or audio system 120. The STB 110 is configured to receive broadcast streams from one or more sources 130, 140, 150. For example the STB 110 can be part of a satellite system that employs a satellite dish 132 to receive a broadcast stream from a satellite 130. In another embodiment, the STB 110 can be a digital television or radio receiver that employs an antenna 142 to receive a digital broadcast stream from a digital broadcasting tower 140. In yet another embodiment, the STB 110 can be connected to a cable system that provides a digital broadcast stream from a cable company 150. In certain embodiments, the STB 110 can be configured to receive digital broadcast streams from any combination of sources 130, 140, 150. It should be understood that these sources of digital broadcast streams are merely illustrative; other possible sources for digital broadcast streams will be apparent to one skilled in the art given the benefit of this disclosure.

The broadcast streams are the channels or stations provided by the satellite, television, radio, or cable provider. The channels or stations provided, depending on the provider, can include television and movie content channels, music channels, and information regarding the content of the channels digital broadcast. For example, many cable and satellite providers include both traditional television channels (CBS, HBO, TBS, etc.) as well music channels based on style or genre (classic rock, opera, heavy metal, etc.).

In the embodiment of FIG. 1, the consumer electronics device 110 is a set top box designed to be connected to a user's display device and audio system 120 such as a television and stereo system for outputting content from a received digital broadcast stream. However, in other embodiments, the consumer electronics device 110 can be a stand-alone device that includes its own video and audio reproduction capabilities, which does not need to be connected to a user's display device and/or audio system 120. Other possible embodiments will be apparent to one skilled in the art given the benefit of this disclosure.

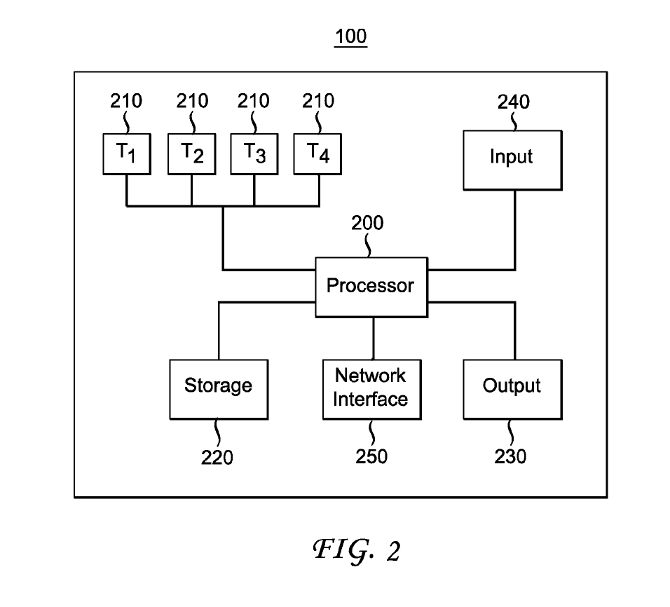

FIG. 2 is a block diagram depicting the elements of consumer electronics device 110 in accordance with one embodiment. In this embodiment, the consumer electronic device comprises a processor 200, multiple tuners (T1, T2, T3, T4) 210, storage 220, and an output interface 230. In some embodiments, the consumer electronics device can further include an input interface 240. Each of these elements will be discussed in more detail below.

The processor 200 controls the operation of the DVR 110. The processor runs the software that operates the DVR 110 as well as provides the functionality of the variable real time buffer. This includes allocating space in the storage 220 to provide a real time buffer, determining which of the multiple tuners 210 are available to use the real time buffer, and allocating the space of the real time buffer to the available tuners 210. The processor 200 is connected to the tuners 210, storage 220, output interface 230, and, in some embodiments, input interface 240, and network interface 250 and handles the transfer and processing of information between these elements. The processor 200 can be general/processor or a processor dedicated for a specific functionality. In certain embodiments there can be multiple processors.

The multiple tuners 210 are configured to receive a broadcast streams containing content. The type and configuration of the tuners 210 depends on the source of the broadcast streams. As such, the tuners 210 can be configured to receive satellite broadcasts, over-the-air broadcasts, cable broadcasts, IP streams or any combination thereof. The tuners allow the DVR 110 to access and decode the various channels or stations that are provided as part of the digital broadcast streams. The tuners can be for tuning in multiple different channels or stations of the same format or source, or different channels or stations of different multiple formats or sources.

The storage 220 is where the software and other information used by the consumer electronics device are stored. The storage 220 can include volatile memory (RAM), non-volatile memory (EEPROM), magnetic media (hard drive), optical media (CD/DVD-ROM), or flash based storage. The storage 220 typically includes memory as well as large capacity storage such as a hard-drive. The hard drive is where the space is allocated for providing the real time buffer.

The output interface 230 is configured to provide the content of the broadcast streams and real time buffer in the correct format for outputting on a video display or audio device 120. The proper format can include the codec for the content to be output as well as the connector type used to connect to an external video display device or audio device or in some embodiments, the onboard display or speakers. The output interface 230 can also provide the graphics and menus used to indicate the content, and information about the content, available on the DVR 110.

In some embodiments the consumer electronic device 110 can further include an input interface 240. The input interface 240 allows the user to interact with the DVR 110. The input interface 240 allows information, such as a user's preference, to be provided to the DVR 110. The input interface 240 also allows for the selection of content available on the DVR 110. The input interface 240 can also handle the interfacing with the various devices that can be used to input information, such a remotes, keyboards, etc.

The DVR 110 can also include a network interface 250. The network interface 250 handles the communication of the DVR 110 with other devices over a network. Examples of suitable networks include Ethernet or multimedia over coaxial (MoCa) networks. Other types of suitable home networks will be apparent to one skilled in the art given the benefit of this disclosure.

It should be understood that the elements set forth in FIG. 2 are illustrative. The electronic device 110 can include any number of elements and certain elements can provide part or all of the functionality of other elements. For example, much of the functionality of the input interface 220 and output interface 230 can be performed by the processor 200 or multiple general or dedicated processors. Likewise, network connectively can be implemented as part of or separate from either the output interface 230 or the input interface 240. Other possible implementation will be apparent to on skilled in the art given the benefit of this disclosure.

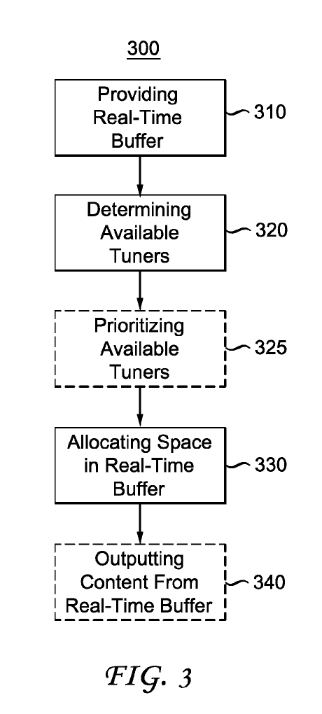

FIG. 3 is a flow diagram depicting a method 300 for a allocating space in a real time buffer. At its most basic, the method involves three steps. The first step is providing a real time buffer (step 310). Then it is determined which tuners are available to make use of the real time buffer (step 320). Finally space in the real time buffer is allocated to the available tuners (step 330). In certain embodiments, the method can include additional steps such as prioritizing available tuners (step 325) and outputting the content from the real time buffer (step 340). Each of these steps will be discussed in more detail below.

Step 310 involves providing a real time buffer. The real time buffer is space set aside or otherwise allocated in the storage 220, such as a hard drive, for buffering content being received by tuners not otherwise being used to record programs to the hard drive or other storage 210 for viewing at a later time. The allocation of space for the real time buffer is performed by the processor 200. The size or amount of storage space can be pre-set, user specified, or dynamically adjusted based on a number of factors including, but not limited to, total size of storage, size of available storage, the number of tuners, and number of available tuners. Other possible implementations will be apparent to one skilled in the art given the benefit of this disclosure.

In step 320, the tuners 210 available to make use of the real time buffer are determined. The tuners 210 are considered available to use the real time buffer if they are not otherwise in use to record content for playback at a later date. This determination is made by processer 200. The processor 200 has access to data regarding the total number of tuners 210 as well as which of those tuners 210 are currently in use recording content. Those tuners not in use can be considered as available to use the real time buffer.

In certain embodiments, after the available tuners are determined (step 320) an additional step of prioritizing the available tuners can be performed (step 325). The priority of tuners can depend on the type, functionality, or current use of the tuner (i.e. what channel the tuner is currently tuned to). For example, one of the available tuners could be in use tuned to the channel that is currently being displayed on the display device 120 indicating that the user is watching that channel. In another example, the DVR 110 could have different types of tuners, such as antenna, cable, satellite, wherein each is capable of tuning to a different type of broadcast stream with different channel availability. In still another example, the channel, programming, or content the tuner is currently tuned to could factor into its prioritization. Likewise, future content that the tuner is scheduled to tune to could also factor into the prioritization of the tuner. The priority of an available tuner can then be used in the determination of allocation of space (step 330), if any, in the real time buffer for that particular available tuner.

Possible implementations of prioritization and allocation can be seen in the following examples.

### Example 1

There are four tuners 210 which are denoted as T1 to T4 respectively. The tuners 210 are capable of tuning to programming or content that is delivered from satellite, terrestrial, cable, and/or Internet source. Also in this example, it is assumed that the tuners are available and will not be occupied by other functions (e.g. recording preselected choices for the DVR 110).

In this example, T1 will be used to tune to current programming that a user will want to watch. This would be known as the primary media channel. During this time T2, T3, and T4 are tuned to channels as well. These channels are selected in view of a preference engine that is used to predict what channels a particular user or users are likely to tune to. For example, if a user's previous viewing habits are that they enjoy watching news programming, T2-T4 are tuned to news programming. Obviously, other programming choices can be selected where a mix of programming can be selected. In another example, T2 would be tuned to HBO, T3 to ESPN, and T4 to CNN. Other channels can be selected, as well in view of the preference engine. Similarly, the preferences of multiple users can considered when selecting content. In certain such embodiments the viewing preferences of certain users can be given priority over other users.

The programming or content that is being tuned to for T2-T4 is being stored in a real time buffer, which has a predetermined size which equates to a length of time available for storage. For this example, the buffer stores a total of six hours of high definition programming, where the six hours of programming is a six hours of programming previously broadcasted on channels T2-T4. Additionally, a real time buffer can be allocated for T1, as well.

A sliding widow is created where the present disclosure will allocate a part of the buffer to a specific channel, and this sliding window provided by the buffer allows a user to play back to any point that was previously recorded. For example, if a sliding window is known as having two hour duration, a user can rewind back to any period within that two hours.

In the present example, the system divides the six hours of storage equally across T2 to T4, so each channel has two hours of real time buffer space allocated for each channel. That is, the buffer will allow a user to watch the previous two hours of programming on HBO, ESPN, and CNN.

The present disclosure provides a first function where the space in the buffer is dynamically allocated in view of the preferences, where the amount of time allocated in the real time buffer for a particular channel is changed in view of preferences of the user or users. Such preference can be the channels themselves, programs, time of day, type of programming of friends of the user watching programming, buffer size available, and the like.

This provides the feature that over time, the allocation of buffer space to HBO is expanded (to 3 hours) while buffer space allocated for CNN is reduced (to an hour) in view of the preferences of a user or users. Hence, if the buffer allocation changes, a user will be able to go back to the previous three hours of programming on HBO while the time of previous programming for CNN is collapsed to only an hour.

Variations of the real time buffer can be made if a particular tuner is used for recording a show for future playback (either done by choice or is done automatically in view of user preferences) where the real time buffer size will be increased for the available tuners not in use recording a show.

Hence, in the present example, T1 is tuned to the actual channel a user is watching. T2 is being used to tune to a movie on HBO. The buffer size then would increase for T3 to T4 from two to three hours because the buffer space for T2 is not being used as T2 is recording programming directly to the “PVR”. The allocation of the real time buffer would then fall back to two hours per T2-T4, when the recording of programming of T2 ends.

### Example 2

Starting with the same situation where T1 is used for tuning to programming to a selected user channel, and T2-T4 is tuned to HBO, ESPN, and CNN respectively. Also, again a six hour real time buffer is used for storing programming from channels T2 to T4.

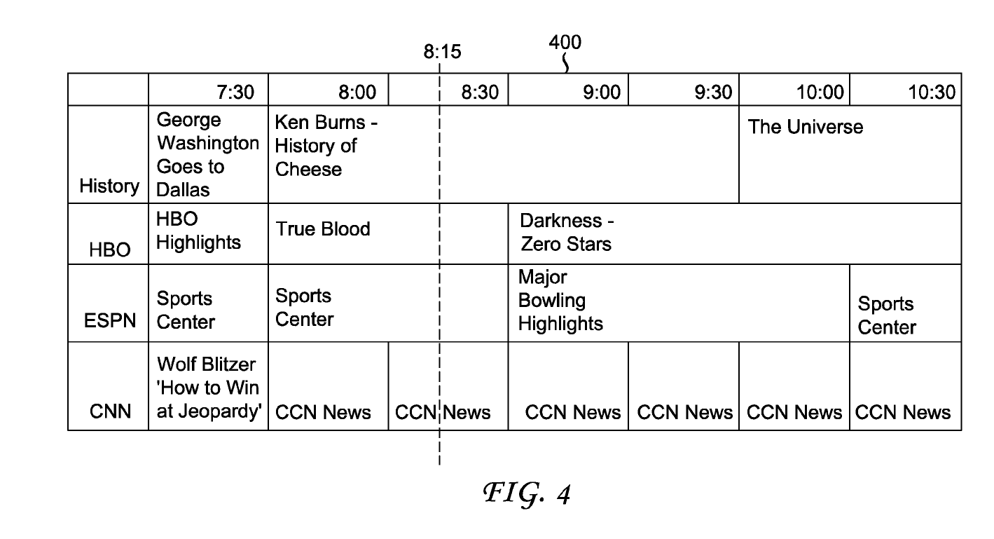

In this example, the buffer allocation to each channel is changed depending on the programming that is on each channel, where the length of each show on a channel impacts the allocation of buffer space. The allocation of buffer space is made to attempt to capture not only the current show that is being broadcasted on a channel but the previous show that was broadcasted on a channel as well. An example of scheduled programming can be seen in the program guide 400 of FIG. 4

For example, if it were 8:15, the buffer will allocate 1.5 hours for HBO (True Blood, current show (1 hr) HBO Highlights, previous show (0.5 hr)). ESPN would have 1.5 hours for the buffer (Sports Center, current show (1 hr), Sports Center, previous show (0.5)). CNN would have an hour allocated for both the previous CNN News show (0.5 hr) and the current CNN News (0.5 hr)). The extra hour of space for the buffer could be allocated however to any channel, or programming.

If it were 9:15, though, the requirements of the buffer would change where HBO would require 3 hours of programming to be buffered (Darkness, current show (2 hrs) and True Blood, previous show (1 hr). Likewise, ESPN would be adjusted where 2.5 hrs are used for the buffer (1.5 hrs for Major Bowling Highlights as the current program and 1 Hr for Sports Center).

The remaining space for the real time buffer would be 0.5 hrs. The present disclosure provides several options as to how to deal with this case for CNN. The disclosure can default to a sliding window of 0.5 hr which ignores the length of programming on a channel (8:45-9:15). This can be done because a preference engine can determine that the user doesn't care about the CNN programming as much as ESPN or HBO programming. Additionally, this can be done because of the genre of programming (news versus a movie).

Another option is that the device could temporarily use an additional buffer (HDD space) to buffer the CNN News from 8:30 to 9 and 9:00 on. This temporary use would end when the space for the real time buffer is freed up.

Once the space of the real time buffer is allocated (step 330), the content of the real time buffer can be output (step 335). As set forth above, the use of the real time buffer allows the user to user to rewind or otherwise go back the amount of time allotted by the real time buffer to playback a portion of the program or content that the user may have missed while watching a different channel or broadcast stream. Other trick play functions such as pause, fast forward, skip ahead may also be supported in the playback of content outputted from the real time buffer.

While the example set forth above has focused on an electronic device, it should be understood that the present disclosure can also be embedded in a computer program product (e.g. an application), which comprises all the features enabling the implementation of the methods described herein, and which, when loaded in a computer system, is able to carry out these methods. Computer program or application in the present context means any expression, in any language, code or notation, of a set of instructions intended to cause a system having an information processing capability to perform a particular function either directly or after either or both of the following a) conversion to another language, code or notation; b) reproduction in a different material form.

Additionally, the description above is intended by way of example only and is not intended to limit the present disclosure in any way, except as set forth in the following claims.

1. In a device having a multiple tuners, a method comprising:
providing a buffer for storing content from the multiple tuners;
determining which of the multiple tuners is available to make use of the buffer; and
allocating space in the buffer to the available tuners.

2. The method of claim 1, further comprising the step of prioritizing available tuners based on the function of the tuner.

3. The method of claim 1, wherein the allocation is based on preferences.

4. The method of claim 3, wherein preferences are specified by a user.

5. The method of claim 4, wherein preferences are based on a user's usage of the device.

6. The method of claim 4, wherein there are multiple users.

7. The method of claim 3, wherein the preferences are from the group comprising channel, content, time of day, and genre.

8. The method of claim 1, wherein allocation is based on available space in the buffer.

9. The method claim 1, wherein allocation is based on the duration of buffered content.

10. The method of claim 1, further comprising the step of creating additional buffer capacity.

11. The method of claim 1, further comprising the step of outputting the content of the buffer.

12. A system for allocating space in a buffer, the system comprising:
multiple tuners to receive content;
storage for providing a buffer;
a processor configured to determine which of the multiple tuners is available to make use of the buffer and allocate space in the buffer to the available tuners; and
an output interface configured to output the content of the buffer.

13. The system of claim 12, wherein the system comprises a set-top box.

14. The system of claim 12, further comprising an input interface for receiving commands from a user.

15. The system of claim 12, further comprising a network connection for connecting the system to a network.
